(19) United States
(12) Patent Application Publication
(10) Pub. No.: US 2017/0261434 A1
(43) Pub. Date: Sep. 14, 2017

(54) SERS SUBSTRATE

(71) Applicant: National Tsing Hua University, Hsinchu (TW)

(72) Inventors: Shang-Jr Gwo, Hsin-Chu City (TW); Hung-Ying Chen, Yunlin County (TW); Meng-Hsien Lin, Hsinchu (TW)

(21) Appl. No.: 15/065,253

(22) Filed: Mar. 9, 2016

(51) Int. Cl. G01N 21/65

(52) U.S. Cl. CPC G01N 21/658; G01N 2201/0612

(57) ABSTRACT

Reliable, scalable, and tunable SERS substrates are developed for quantitative SERS measurements and the limit of detection (LOD) can be down to single molecule level. This is achieved by the precise control of SERS enhancement factor and detection hot zone using ligand-regulated nanoparticle superlattices film with a built-in internal standard. The establishment of quantitative SERS technique will open up many exciting opportunities for both fundamental and applied research areas.

### BACKGROUND OF THE INVENTION

1. Field of the Invention

The present invention relates to SERS substrates and their forming methods and applications.

2. Description of Related Art

Raman spectroscopy arises from the inelastic light scattering by molecular vibrations, which could provide “fingerprint” information for molecular diagnostics. However, the inherently low scattering intensity of conventional Raman spectroscopy limits its widespread applicability. Over the last few decades, surface enhanced Raman spectroscopy (SERS)¹⁻⁴ has received intense attention because of its great potential for ultrasensitive detection down to the single-molecular level.⁵⁻⁹ In SERS, light excitation of surface plasmon resonances in noble-metal nanostructures significantly enhance and localize the incident electromagnetic field at nanoscale “hot spots”. The Raman intensity of molecules, which are placed in close proximity to the hot spots of SERS substrate, can be dramatically amplified with an enhancement factor frequently above 10⁶.¹⁰⁻¹²

However, due to the random distribution of hot spots on the SERS substrate, only part of the analytes can be really accounted for. For this reason, although it is obvious that the precise determination of analyte concentration is critical for bio- and chemical sensing applications, there are only a few reports focused on the realization of quantitative SERS measurements.¹³⁻¹⁵ To realize highly sensitive and reliable SERS for quantitative measurements, there have been numerous attempts to simultaneously achieve large Raman enhancement factor and reproducibility of hot spots using different nanofabrication techniques.¹⁶⁻²¹ However, until now it is still unattainable because of limited uniformity and controllability of hot spots in available

### REFERENCES

(1) Fleischmann M.; Hendra P. J.; McQuillan A. J. Chem. Phys. Lett. 1974, 26, 163-166; (2) Jeanmaire, D. L.; Van Duyne, R. P. J. Electroanal. Chem. 1977, 84, 1-20; (3) Moskovits, M. Rev. Mod. Phys. 1985, 57, 783-826; (4) Le Ru, E. C.; Etchegoin, P. G. Principles of Surface-Enhanced Raman Spectroscopy and Related Plasmonic Effects (Elsevier, Amsterdam, 2009); (5) Nie, S.; Emory, S. R. Science 1997, 275, 1102-1106; (6) Kneipp, K.; Wang, Y.; Kneipp, H.; Perelman, L. T.; Itzkan, I.; Dasari, R. R.; Feld, M. S. Phys. Rev. Lett. 1997, 78, 1667-1670; (7) Le Ru, E. C.; Meyer, M.; Etchegoin, P. G. J. Phys. Chem. B 2006, 110, 1944-1948; (8) Dieringer, J. A.; Lettan, L. B.; Scheidt, K. A.; Van Duyne, R. P. A J. Am. Chem. Soc. 2007, 129, 16249-16256; (9) Kleinman, S. L.; Ringe, E.; Valley, N.; Wustholz, K. L.; Phillips, E.; Scheidt, K. A.; Schatz, G. C.; Van Duyne, R. P. J. Am. Chem. Soc. 2011, 133, 4115-4122; (10) Le Ru, E. C.; Blackie, E.; Meyer, M.; Etchegoin, P. G. J Phys. Chem. C 2007, 111, 13794-13803; (11) Fang, Y.; Seong, N.-H.; Dlott, D. D. Science 2008, 321, 388-392; (12) Kleinman, S. L.; Frontiera, R. R., Henry, A.-I.; Dieringer, J. A.; Van Duyne, R. P. Phys. Chem. Chem. Phys. 2013, 15, 21-36; (13) Bell, S. E. J.; Sirimuthu, N. M. S. Chem. Soc. Rev. 2008, 37, 1012-1024; (14) März, A.; Ackermann, K. R.; Malsch, D.; Bocklitz, T.; Henkel, T.; Popp, J. J. Biophoton. 2009, 2, 232-242; (15) Shen, W.; Lin, X.; Jiang, C.; Li C.; Lin, H.; Huang, J.; Wang, S.; Liu, G.; Yan, X.; Zhong, Q.; Ren, B. Angew. Chem. Int. Ed. 2015, 54, 7308-7312; (16) Freeman, R. G.; Grabar, K. C.; Allison, K. J.; Bright, R. M.; Davis, J. A.; Guthrie, A. P.; Hommer, M. B.; Jackson, M. A.; Smith, P. C.; Walter, D. G.; Natan, M. J. Science 1995, 267, 1629-1632; (17) Jackson, J. B.; Halas, N. J. Proc. Natl. Acad. Sci. USA 2004, 101, 17930-17935; (18) Wang, H.; Levin, C. S.; Halas, N. J. J. Am. Chem. Soc. 2005, 127, 14992-14993; (19) Fan, M.; Brolo, A. G. Phys. Chem. Chem. Phys. 2009, 11, 7381-7389; (20) Li, J. F.; Huang, Y. F.; Ding, Y.; Yang, Z. L.; Li, S. B.; Zhou, X. S.; Fan, F. R.; Zhang, W.; Zhou, Z. Y.; Wu, D. Y.; Ren, B.; Wang, Z. L.; Tian, Z. Q. Nature 2010, 464, 392-395; (21) Lim, D.-K.; Jeon, K.-S.; Hwang, J.-H.; Kim, H.; Kwon, S.; Suh, Y. D.; Nam, J.-M. Nature Nanotechnol. 2011, 6, 452-460; (22) Banholzer, M. J.; Millstone, J. E.; Qin, L.; Mirkin, C. A. Chem. Soc. Rev. 2008, 37, 885-897; (23) Ko, H.; Singamaneni, S.; Tsukruk, V. V. Small 2008, 4, 1576-1599; (24) Camden, J. P.; Dieringer, J. A.; Zhao, J.; Van Duyne, R. P. Acc. Chem. Res. 2008, 41, 1653-1661; (25) Lin, X.-M.; Cui, Y.; Xu, Y.-H.; Ren, B.; Tian, Z.-Q. Anal. Bioanal. Chem. 2009, 394, 1729-1745; (26) Sharma, B.; Cardinal, M. F.; Kleinman, S. L.; Greeneltch, N. G.; Frontiera, R. R.; Blaber, M. G.; Schatz, G. C.; Van Duyne, R. P. MRS Bull. 2013, 38, 615-624; (27) Lal, S.; Grady, N. K.; Goodrich, G. P.; Halas, N. J. Nano Letters 2006, 6, 2338-2343; (28) Chen, C.-F.; Tzeng, S.-D.; Chen, H.-Y.; Lin K.-J.; Gwo, S. J. Am. Chem. Soc. 2008, 130, 824-826; (29) Zhang, D.; Xie, Y.; Deb, S. K.; Davison, V. J.; Ben-Amotz, D. Anal. Chem. 2005, 77, 3563-3569; (30) Lin, M.-H.; Chen, H.-Y.; Gwo, S. J. Am. Chem. Soc. 2010, 132, 11259-11263; (31) de Gennes, P. G. Rev. Mod. Phys. 1992, 64, 645-648; (32) Johnson, P. B.; Christy, R. W. Phys. Rev. B 1972, 6, 4370-4379; (33) Underwood, S.; Mulvaney, P. Langmuir 1994, 10, 3427-3430; (34) Sönnichsen, C.; Geier, S.; Hecker, N. E.; von Plessen, G.; Feldmann, J.; Ditlbacher, Lamprecht, B.; Krenn, J. R.; Aussenegg, F. R.; Chan, V. C.-H.; Spatz, J. P.; Möller, M. Appl. Phys. Lett. 2000, 77, 2949-2951; (35) Yang, S.-C.; Kobori, H.; He-C.-L.; Lin, M.-H.; Chen, H.-Y.; Li, C.; Kanehra, M.; Teranishi, T.; Gwo, S. Nano Lett. 2010, 10, 632-637; (36) Wood, D. A.; Bain, C. D. Analyst 2012, 137, 35-48; (37) McKee, K. J.; Meyer, M. W.; Smith E. A. Anal. Chem. 2012, 84, 4300-4306; (38) Zhao, Q.; Lu, D.-F.; Liu, D.-L.; Chen, C.; Hu, D.-B.; Qii, Z.-M. Acta Phys.-Chim. Sin. 2014, 30, 1201-1207.

### SUMMARY OF THE INVENTION

A general aspect of the present invention relates to SERS substrates and their forming methods and applications.

In an embodiment of the present invention, a surface enhanced Raman spectroscopy (SERS) substrate for Raman measurements is provided with a substrate, a nanoparticle film, a spin-coated layer, and one or more analytes. The substrate has a first surface receiving a light beam and a second surface opposite to the first surface. The nanoparticle film is formed on the second surface of the substrate and comprises a first monolayer consisted of a two-dimensional nanoparticles array that are near-field coupled with each other. The spin-coated layer is on the nanoparticle film. The one or more analytes are embedded in the spin-coated layer or dispersed in a fluid displaced on the spin-coated layer.

In an embodiment, the limit of detection of the Raman measurements using the SERS substrate is single molecule level. In an embodiment, the SERS substrate has a linear response with a correlation coefficient R>0.999 over an areal density range 5-5,000 molecules per μm². In an embodiment, the Raman peak intensity of Raman spectra from the SERS substrate has a standard deviation less than 5%.

In an embodiment, the substrate comprises a quartz, an indium tin oxide (ITO), a silicon, or a polymer substrate. In an embodiment, the spin-coated layer is a dielectric layer made by a spin coating procedure. In an embodiment, the spin-coated layer is a spin-on-glass (SiO2) layer. In an embodiment, the spin-coated layer is a spin-coated polymer layer. In an embodiment, the SERS substrate further comprises an adsorption layer on the spin-coated layer and the one or more analytes are dispersed in a fluid displaced on the spin-coated layer.

In an embodiment, the nanoparticle film is made by the steps of: preparing a nanoparticle solution, which comprises a solvent and supersaturated nanoparticles with surface ligand molecules; and dip coating a substrate to the nanoparticle solutions to form the first monolayer of the nanoparticles on the substrate, so that the first monolayer of the nanoparticles construct the nanoparticle film.

In an embodiment, the SERS substrate further comprises one or more monolayers disposed on the first monolayer. In an embodiment, the nanoparticle film has tunable plasmonic properties and the tunable plasmonic properties are determined by the number of the monolayers, the material of the nanoparticles, the size of the nanoparticles, and the gap between nanoparticles.

In an embodiment, the nanoparticles are made of a metal or a core coated with a metal. In an embodiment, the metal comprises gold or silver. In an embodiment, the nanoparticles comprise gold or silver nanoparticles with surface ligand molecules, and the surface ligand molecules comprise alkanethiols.

### BRIEF DESCRIPTION OF THE DRAWINGS

FIG. 1 illustrates a surface enhanced Raman spectroscopy (SERS) analytical substrate according to a preferred embodiment of the present invention.

FIG. 2A is a FE-SEM image of one-monolayer (1 ML) close-packed AgNP film on a quartz substrate.

FIG. 2B shows transmission and reflection photographs of a large-area highly uniform 1 ML AgNP film on a quartz substrate according to a preferred embodiment of the present invention.

FIG. 2C shows the structure of the SERS substrate and the analyte layer according to a preferred embodiment of the present invention.

FIG. 2D shows Raman spectra obtained from a CV/SOG layer on a AgNP film, a bare AgNP film, and a bare CV layer, respectively.

FIGS. 3A, 3B, and 3C show simulation results of the analytical SERS substrate according to the preferred embodiment of this invention.

FIGS. 4A and 4B show the spectra of the SERS substrate of FIG. 1 for three different analyte molecules.

FIG. 5A, 5B, 5C, and 5D shows the uniformity of the SERS substrate of FIG. 1.

FIGS. 6A and 6B show enhancement factor of AgNP SERS substrate of FIG. 1.

FIGS. 7A and 7B show the quantitative capability of the SERS substrate of FIG. 1

FIG. 8 shows a SERS substrate according to another embodiment of this invention.

FIG. 9 shows a SERS substrate according to another embodiment of this invention.

### DETAILED DESCRIPTION OF THE INVENTION

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations and components are not been described in detail in order not to unnecessarily obscure the present invention. While drawings are illustrated in details, it is appreciated that the quantity of the disclosed components may be greater or less than that disclosed, except expressly restricting the amount of the components. Wherever possible, the same or similar reference numbers are used in drawings and the description to refer to the same or like parts.

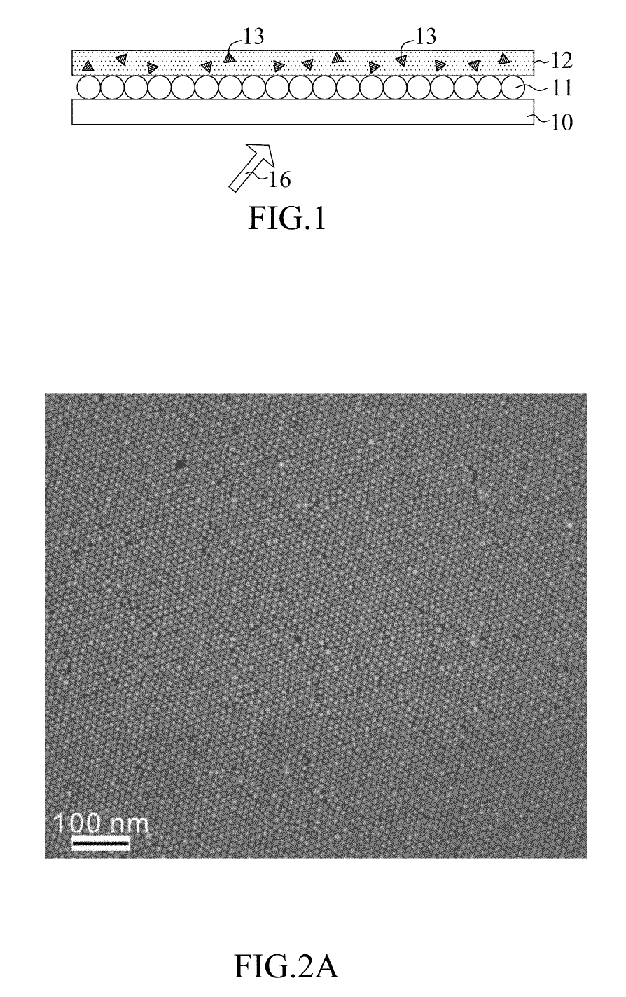

FIG. 1 illustrates a surface enhanced Raman spectroscopy (SERS) analytical substrate according to a preferred embodiment of the present invention. Referring to FIG. 1, the SERS analytical substrate comprises a substrate 10, a nanoparticle film 11, a spin-coated layer 12, and one or more analytes 13. The substrate 10 has a first surface for receiving a light beam 16 from a SERS detection equipment and a second surface opposite to the first surface. The nanoparticle film 11 is formed on the second surface of the substrate 10 and comprises one or more monolayers with each monolayer consisting of a two-dimensional nanoparticles array that are near-field coupled with one another. The spin-coated layer 12 is formed on the nanoparticle film 11 by a spin coating procedure. In this preferred embodiment, one or more analytes 13 are embedded in the spin-coated layer 12.

Referring to FIG. 1, the nanoparticle film 11 is formed on the second surface of the substrate 10 by a method recited in applicants' prior application, U.S. Pat. No. 8,309,185, entitled “Nanoparticle film and forming method and application thereof,” the entire contents of which are incorporated herein by reference.

In an embodiment, the nanoparticles are made of a metal or a core coated with a metal. In an embodiment, the metal comprises gold or silver. In the preferred embodiment, the nanoparticle film 11 is a silver (Ag) nanoparticle film. In other embodiments of this invention, the nanoparticle film could be a gold (Au) nanoparticle film or a composite nanoparticle film composed of silver and gold nanoparticles. In the preferred embodiment, crystal violet (CV) molecules are selected as the analytes. The spin-coated layer 12 may be a spin-on-glass layer or a spin-coated polymer layer.

The following describes the detail to form a SERS substrate for Raman measurements according the preferred embodiment of the present invention.

Diethylene glycol (DEG) solution of silver colloidal nanoparticles (Ag colloids) is firstly prepared by mixing 15 mL of poly(acrylic acid) (PAA)/DEG solution (0.81 g PAA+15 mL DEG) with a 3 mL silver nitrate mixture (0.1 g AgNO3+3 mL DEG) at 245° C. (the boiling point of DEG) and is maintained for 10 min. Then a two-step, two-phase colloidal method²⁸ is used to synthesize octadecanethiolate-passivated AgNPs. In this step, an AgNP/DEG solution is transferred to toluene using TOAB (Tetraoctylammonium bromide, [CH₃(CH₂)₇]₄N(Br)) as the transfer agent, and AgNPs are capped with octadecanethiolates in toluene. Specifically, a 5 mL AgNP/DEG solution is mixed with a 10 mL, 100 mM TOAB/toluene solution, a 10 mL, 100 mM octadecanethiolate/toluene solution, and 25 mL of toluene. The mixture is stirred vigorously for about 10 min and stood for 6 h. Then, the bottom DEG solution is removed. Finally, a centrifuge is utilized to purge the octadecanethiolate-passivated AgNP/toluene solution. Colloidal AgNPs exhibit many advantages to serve as plasmonic building blocks, such as well-controlled synthesis, size monodispersity, good shape control, facile surface functionalization, and excellent plasmonic properties in the visible light region. As for the large-scale self-assembly of plasmonic nanoparticle films, the prior application U.S. Pat. No. 8,309,185 provides a simple and efficient method for forming large-area (>1 cm²), single- or multiple-layer AgNP films.³⁰ In comparison to a single-layer AnNP film, Janus nanoparticles³¹ that simultaneously display two distinctly different surface properties are utilized to form multiple-layer AgNP films. Using this method, an arbitrary number of close-packed nanoparticle monolayers can be formed by using layer-by-layer assembly from a suspension of thiolate-passivated AgNPs, similar to the Langmuir-Blodgett technique.

For example, the metastable, supersaturated octadecanethiolate-passivated silver nanoparticle solution is then employed to form a monolayer of silver nanoparticles on a substrate by a dip coating method according to the embodiment of the present invention. The nanoparticles monolayer is transferred to a chosen substrate, for example, quartz, indium tin oxide (ITO), silicon, polymer, or other substrates, consecutively by dipping the substrate and pulling it out perpendicular to the liquid surface. During the dip coating, the nanoparticle solution may be controlled at room temperature or an elevated temperature, such as 70° C. The elevated temperature may increase the capillarity of the nanoparticle solution.

For example, to stack more nanoparticle monolayers, it would require that the exposed functional group of the monolayer to be converted to a solvent-phobic group. But as-synthesized nanoparticles are typically symmetric in surface ligand structure, allowing only the single monolayer formation. Therefore, in order to construct multilayered structures, it is essential to create monolayers of Janus nanoparticles (particles displaying simultaneously two distinctly different surface properties). The plasma-based surface modification technique described in US patent Application, application Ser. No. 12/502,226, entitled “Method for Modifying Surface in Selective Areas and Method for Forming Patterns,” is suitable for this purpose and adopted by the present invention, the entire content of which is incorporated herein by references.

In the preferred embodiment, the spin-coated layer 3 is a spin-on-glass (SiO₂) layer, and the SiO₂ layer is prepared from a diluted SOG solution (liquid form of methylsiloxane, IC1-200, Futurrex) by a spin coating procedure. The thickness of SiO₂ layer can be controlled by the spinning speed. To prepare 5-nm-thick SiO₂ layer, SOG is spun for 40 s at 5,000 rpm and then drying at room temperature for a few minutes. To prepare the samples for Raman measurements, the analyte molecules are first dissolved in the spin-on-glass solution and then spun on under the same conditions. The analyte molecules do not have any chemical reaction with the SOG. The areal density of analytes can be estimated by the mass concentration of analytes in the SOG solution. The areal densities of analytes are estimated by the concentration of analytes and the thickness of SOG before drying. The volume contraction ratio (V_{dry}/V_{wet}) depends on the concentration of diluted SOG solution and can be experimentally determined.

In the preferred embodiment of this invention, an alkanethiolate ligand-regulated silver nanoparticle (AgNP) superlattice film is applied to achieve highly enhanced and uniform Raman measurements over a large area (>1 cm²). The large-scale self-assembly of 6-nm-diameter AgNPs allows for the formation of regular, close-packed AgNP superlattices, which can function as SERS substrates with excellent uniformity (<5% variation) and large Raman enhancement factor (>1.2×10⁷). In particular, the SERS signal from the thiolate ligands on the AgNP surface is found to be a robust internal calibration standard for quantitative SERS measurements. Using these substrates, the capability of quantitative SERS detection is demonstrated by measuring the areal density of crystal violet (CV) molecules embedded in a ultrathin (5 nm) spin-on-glass “hot zone”, which shows a linear response over a wide dynamic range of CV concentration (5-5,000 molecules/μm²).

There are several major SERS issues need to be addressed to realize quantitative SERS in an efficient and reliable way. First of all, uniform and large SERS substrates are crucial for quantitative measurements. But the required nanofabrication precision to create metal nanostructure arrays with uniform hot spot properties is very difficult to be accomplished.^{18,21} In the preferred embodiment of this invention, a self-assembled AgNP superlattices film regulated by the alkanethiolate surface ligands can resolve this SERS issue.

Second, in order to obtain a reproducible SERS signal, sub-nanometer precise control of the distance between the analyte and the hot spot is necessary because that the SERS signal can be drastically changed even the location of analyte relative to the hot spot is only slightly varied on the nanometer scale.^{11,12,27} The advantage of using alkanethiolate surface ligand for nanoparticle self-assembly is that precise interparticle gap control can be achieved by using different alkanethiolate chain length.²⁸

In SERS, the overall signal intensity is essentially the sum of signals from all the analytes on the whole detection area covered by the excitation laser beam. In a study by Dlott et al.,¹¹ it has been shown that the local Raman enhancement factors on Ag-film-on-nanospheres SERS substrate exhibit a broad distribution ranging from 10⁴ to 10¹⁰. Notably, one-half of the overall SERS signal comes from the hot spots with enhancement factors greater than 10⁸, which only account for less than 1% of total hot spots. These findings answer most of the questions about the inhomogeneous nature of the SERS substrates reported in the literature. Over the years, many research efforts have been devoted to optimizing SERS substrates in order to provide the largest magnitude of SERS enhancement. In contrast, the strategy proposed in this invention for reliable quantitative SERS measurements is to avoid anomalously hot detection sites (conventional hot spots), and position analytes in a planar and uniform “hot zone”, which is several nanometers above the AgNP film. The achieved Raman enhancement factor is spatially uniform and sufficiently high (>10⁷) for single-molecule detection.

The third issue of quantitative SERS concerns about the measurement of absolute SERS signal, which is very difficult to achieve by conventional SERS techniques. The Raman scattering intensity typically depends on various instrumental conditions, rendering it difficult to reproduce the signal even for the same sample. A possible solution for this problem is to establish internal standards,^{14,15,29} which might come from the SERS signals of independent and stable components included in the sample. The preferred embodiment of this invention will demonstrate that the SERS signal of passivating alkanethiolate ligands on the AgNP surfaces can be used as a stable internal calibration standard for quantitative SERS measurements.

Three different Raman systems, Raman systems I, II, and III, are used to perform the Raman measurements, and all Raman measurements are performed at room temperature. In the Raman system I, the Raman spectra are acquired using a confocal Raman microscope. A 1 mW (before the microscope), 532-nm diode laser is used to excite the sample through a 100× objective (N.A.=0.9, Olympus) with a laser spot diameter about 2 μm. The two-dimensional (2D) Raman mapping results are acquired on two independent systems, Raman systems II and III. The Ramon system II is a home-built confocal Raman microscope system. A 25-50 μW (after the microscope objective), 532-nm diode laser is used to excite the samples through a 100× objective (N.A.=0.9, Olympus) with a laser spot diameter about 0.25 μm. The Raman system III is a commercial confocal Raman microscope system (LABRAM HR 800 UV, Horiba Jobin-Yvon). A 1 mW (before the microscope), 514-nm Ar-ion laser is used to excite the sample with a laser spot diameter about 0.7 μm.

A commercial package (Lumerical, FDTD solutions v.7.5) is used to perform finite-difference time-domain (FDTD) simulations. The simulated structures of the nanoparticle monolayer film adopted the structure parameters measured by scanning electron microscopy. The in-plane structure (x-y plane) is a hexagonal close-packed array. The unit cell of investigated structure is simulated using periodic boundary conditions along the x- and y-axis, and perfectly matched layers along the propagation direction of the electromagnetic wave (z-axis). The dielectric function of silver is adopted from the experimental data by Johnson and Christy.³² The refractive index of the surrounding medium was assumed to be 1.5.³³ The simulation mesh with is 0.3 nm, and the periodic boundary condition is adopted.

The prior application U.S. Pat. No. 8,309,185, entitled “Nanoparticle film and forming method and application thereof,” have demonstrated that layer-by-layer assembled colloidal gold and silver nanoparticle films exhibit strong and tunable plasmonic response. The adopted self-assembly method for creating nanoparticle films is quite simple, robust, and scalable.^{28,30} In the preferred embodiment of this invention, AgNPs are chosen as the building blocks of SERS substrates because of their superior plasmonic properties among all plasmonic metals.

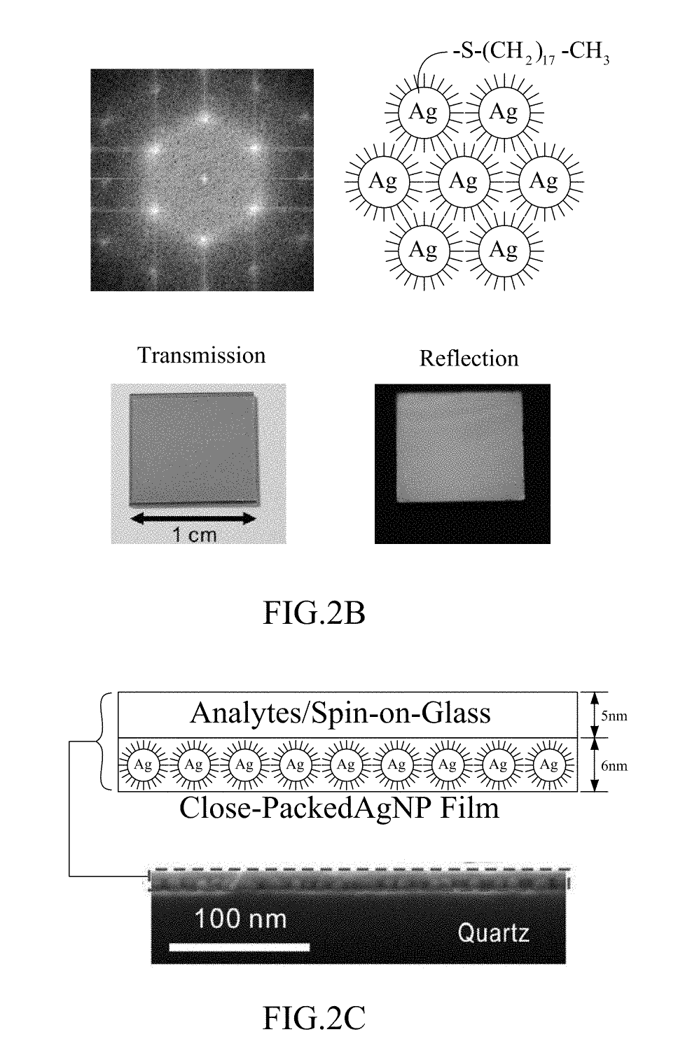

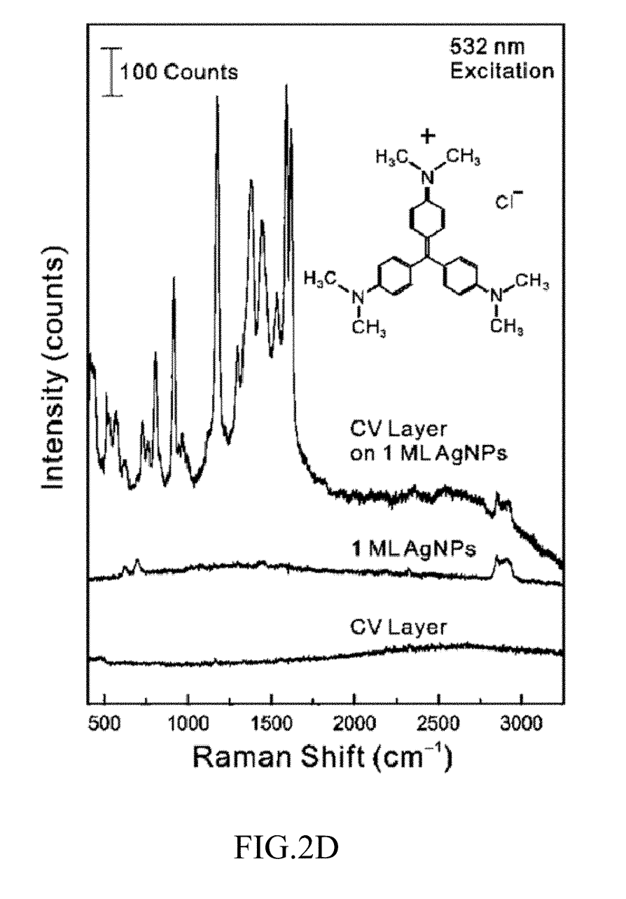

FIG. 2A is a FE-SEM image of one-monolayer (1 ML) close-packed AgNP film on quartz with an image area of 1×0.7 μm². The diffraction pattern was acquired from fast Fourier transform with an image area of 0.7×0.7 μm². The schematic shows that the interparticle gap is regulated by the thiolate chain length. The diffraction pattern via fast Fourier transform confirms the long-range ordering of AgNP superlattice. FIG. 2B shows transmission and reflection photographs of a large-area (1×1 cm²), highly uniform 1 ML AgNP film on quartz, illustrating the effect of collective plasmonic resonance. FIG. 2C shows the structure of the SERS substrate (close-packed AgNP film) and the analyte layer, which is a spin-coated layer of crystal violet (CV) molecules embedded in spin-on-glass (SOG). The cross-sectional SEM image shows the thicknesses of CV/SOG layer and AgNP film are about 5 nm and 6 nm, respectively. FIG. 2D shows Raman spectra (vertically offset for clarity) obtained from a CV/SOG layer on a AgNP film, a bare AgNP film, and a bare CV layer, respectively. The spectra are acquired by using the Raman System I.

Besides protecting the AgNPs from ambient-induced degradation and regulating the formation of hot-spot array, additional important advantage of thiolate ligands on the nanoparticle surface is that the collective plasmon resonance modes of close-packed AgNP films can be varied by changing the near-field coupling strength between adjacent nanoparticles. Using this approach, the plasmonic peak position can be tuned precisely by varying the carbon-chain length of alkanethiolate ligands and the resulting interparticle spacing.²⁸ As shown in FIG. 2B, this plasmonic coupling effect can be readily visualized by the purple and green colors displayed in the transmission and reflection photographs, respectively.

FIG. 2C shows the approach to control the distance between SERS substrate and analytes according to the preferred embodiment of this invention. The analytes were dissolved in SOG solution and then spin-coated on the 1 ML AgNP film. After drying/curing, ultrathin analyte/SOG glass layers can be prepared reproducibly using this method since the concentration of analytes is dilute enough so that the viscosity of SOG is not significantly altered. In the preferred embodiment, CV molecules are utilized as the analytes, which were embedded in a 5-nm-thick SOG layer with an estimated areal density of about 5,000 molecules per μm².

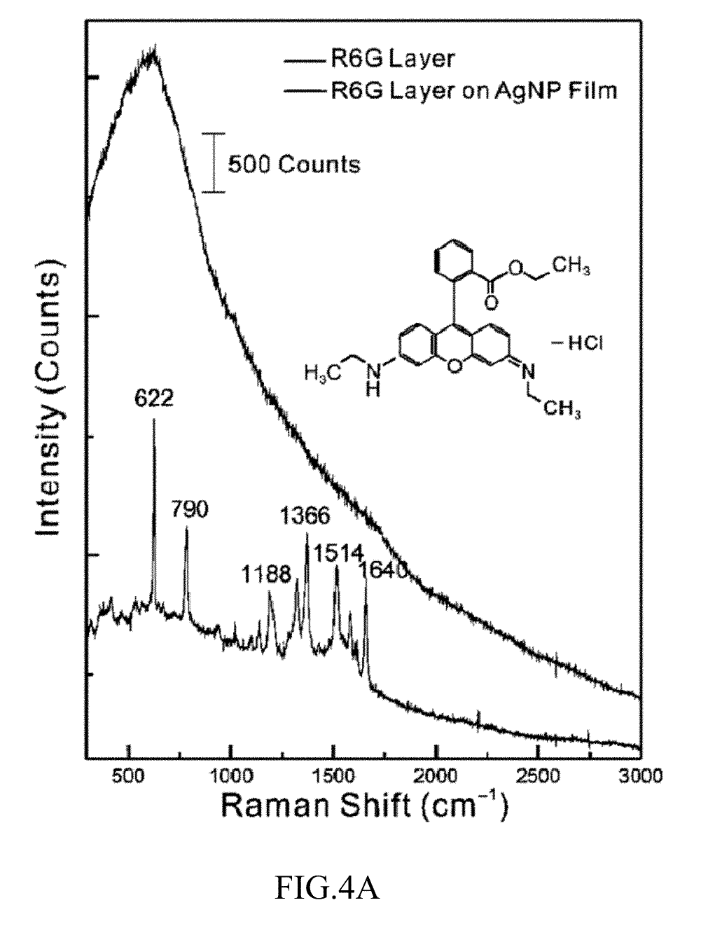

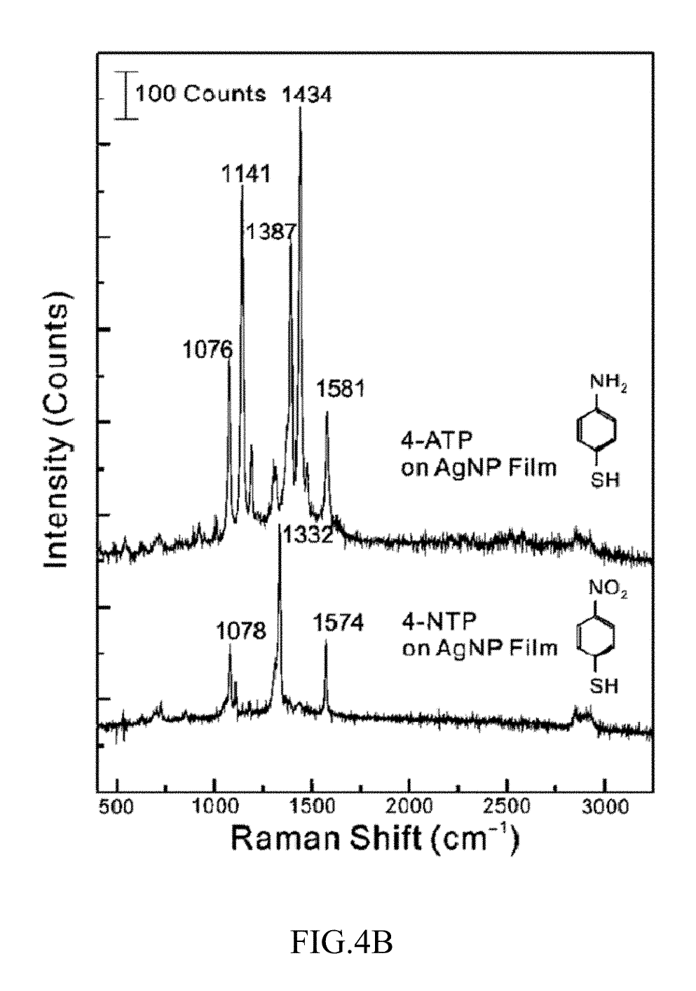

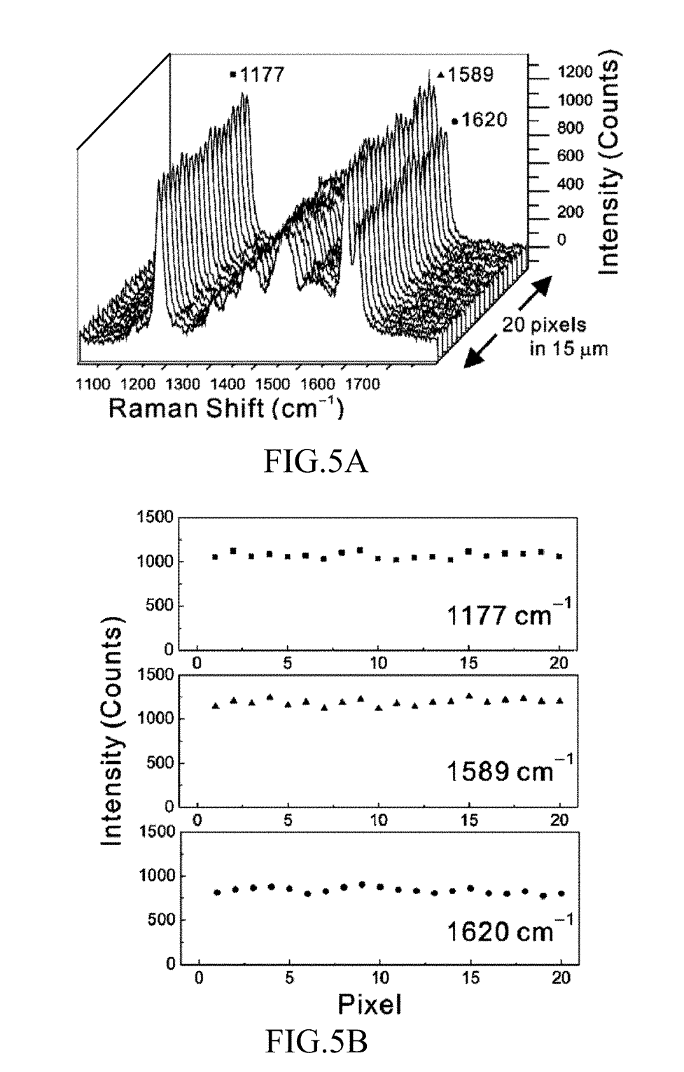

FIG. 2D shows the Raman spectra of a CV/SOG layer on an AgNP film, a bare AgNP film, and a bare CV/SOG layer, respectively. Although the excitation wavelength of 532 nm is in the resonant absorption regime for CV molecules, the strong Raman signal of CV molecules can only be observed with the AgNP film. This result confirms the Raman enhancement via the plasmonic resonance of AgNP film (a supporting figure illustrates the strong dependence on the excitation laser wavelength). In addition, to confirm that this enhancement effect is generally applicable, three different molecules, including rhodamine 6G (R6G), 4-nitrothiophenol (4-NTP) and 4-aminothiophenol (4-ATP) have also been tried, as shown in FIGS. 4A and 4B. It is important to note that this Raman enhancement effect cannot be realized if the wavelength of excitation laser does not match with the plasmonic resonance peak. It is found that the AgNP film exhibited an excellent Raman enhancement uniformity for SERS measurements.

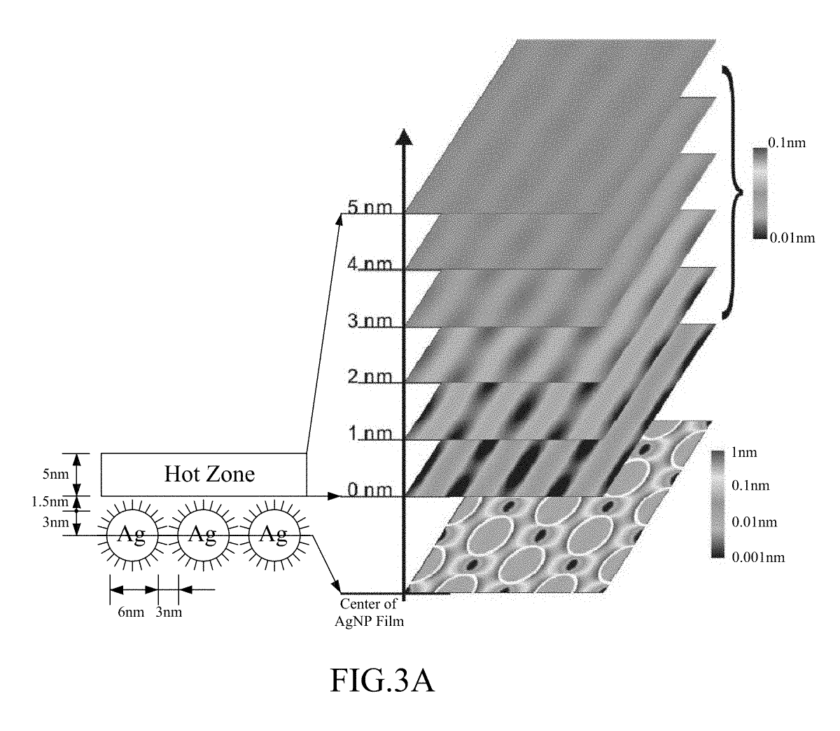

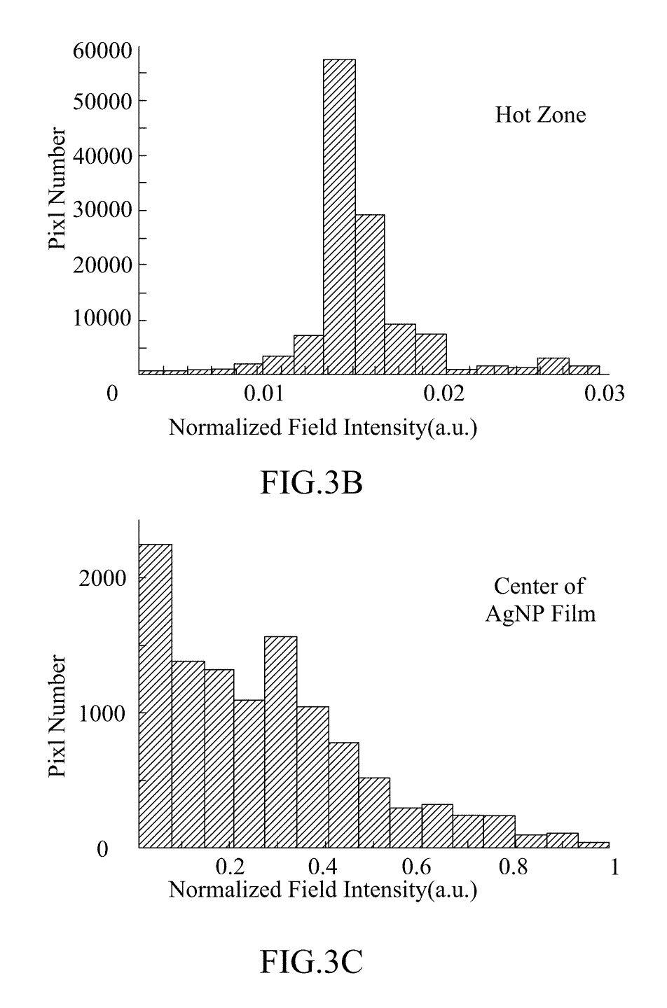

FIGS. 3A, 3B, and 3C show simulation results of the analytical SERS substrate according to the preferred embodiment of this invention. FIG. 3A is a schematic view illustrating the detection hot zone, where the analytes are located in the controllable region. FIG. 3A also show the FDTD simulated electric field intensity (|E|²) distribution at different vertical planes on top of the AgNP film. All the field intensities are normalized to the hottest point in the center plane of the AgNP film. The distribution of hot spots in the center plane of AgNP monolayer film is simulated using a linearly polarized laser at normal incidence. At planes with increasing heights, the features of hot spots become blurred rapidly and the field distribution becomes quite uniform in the detection hot zone. FIG. 3B and FIG. 3C show the statistical analyses of field intensity at the hot zone and at the center plane of AgNP monolayer film, respectively. In particular, the standard deviation of field intensity at the hot zone is only about 10% of the peak value.

As shown in FIGS. 3A, 3B, and 3C, the FDTD simulation shows that all of the analytes can be located in a controllable hot zone and with a uniform enhancement factor. The method introducing analytes of this invention is critical for quantitative SERS measurements because those analytes distribute homogeneously above the AgNP film within a precise spatial range for reproducible SERS detection.

FIGS. 4A and 4B show the spectra of the SERS substrate of FIG. 1 for three different analyte molecules. The areal densities are around 50,000 molecules/μm². FIG. 4A show two Raman spectra obtained for a rhodamine 6G (R6G)/SOG layer on quartz and a R6G/SOG layer on AgNP film, respectively. FIG. 4B show two Raman spectra obtained for a 4-aminothiophenol (4-ATP)/SOG layer on AgNP film (black) and a 4-nitrothiophenol (4-NTP)/SOG layer on AgNP film (red), respectively. The spectra are acquired by using the Raman System I.

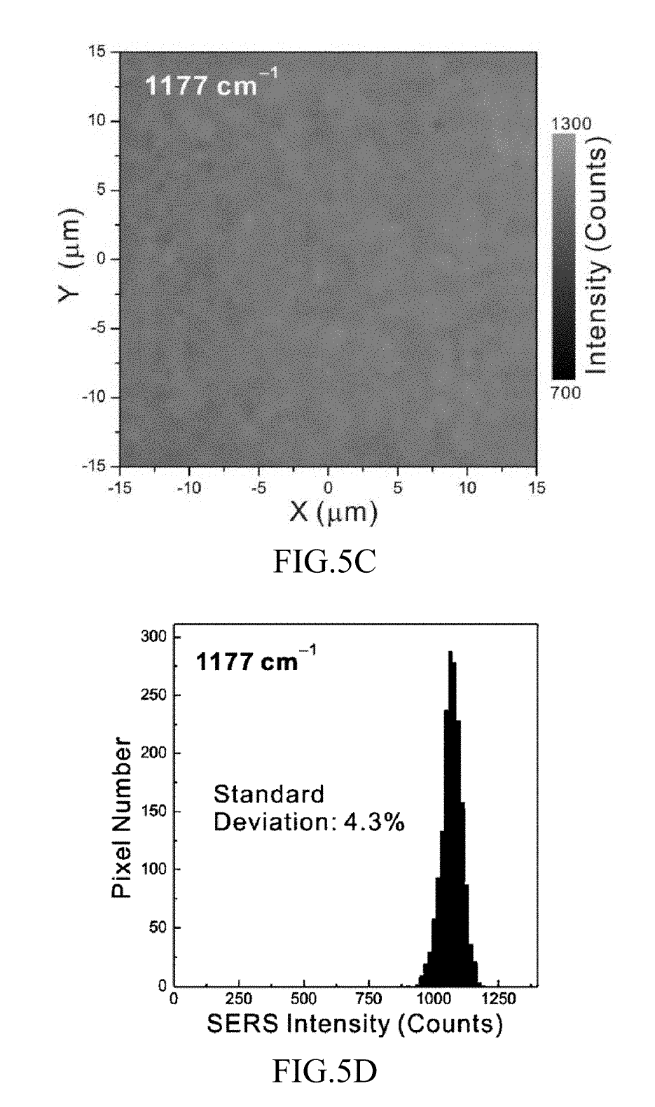

FIG. 5A, 5B, 5C, and 5D shows the uniformity of Raman measurement using the SERS substrate of FIG. 1. The areal densities are around 5,000 molecules/m². The spectra are taken using the Raman System III and the integration time is 1 s. FIGS. 5A, 5B, 5C, and 5D present the Raman mapping results from a CV/SOG layer deposited on the whole imaged area. FIG. 5A shows a Raman linescan with 20 spectra in 15 μm scanning distance and the intensities of some specific CV Raman peaks (i.e., 1177, 1589, and 1620 cm⁻¹) are displayed in FIG. 5B. FIG. 5B shows the variation of SERS intensity at the specific Raman modes of 1177, 1589, and 1620 cm⁻¹, respectively. FIG. 5C is a two-dimensional Raman mapping at the CV Raman peak of 1177 cm⁻¹. The scanning area is 900 μm² and the total number of imaging pixels are 1681 (41×41). As shown in FIG. 5C, every pixel shows a uniform Raman peak intensity. FIG. 5D shows that the standard deviation is only 4.3%, which is a record-low value at the ensemble measurement level.^{13,23} It is worth pointing out that the detected region presented here was randomly selected, and consistent spatial uniformity can be found in the whole SERS substrate.

Uniform hot spot properties across the self-assembled nanoparticles film is an important prerequisite for achieving spatial uniformity in SERS. In the embodiment of this invention, it is accomplished by the formation at highly regular thiolate-encapsulated AgNP superlattice. Another key requirement is the homogeneous distribution of analytes in the designated detection hot zone. The hottest sites on the close-packed AgNP film locate at the interparticle gap, where are spatially blocked by the alkanethiolates.

According to the FDTD simulations shown in FIGS. 3A, 3B, and 3C, the mean field intensity in the designated detection hot zone above the AgNP film is about ten times smaller than that at the hottest sites, but the spatial uniformity is much better. Indeed, there is a tradeoff between enhancement factor and spatial uniformity. The optimized detection geometry adopted in this invention could provide both strong enhancement factor for single molecule detection and high spatial uniformity. The reported SERS enhancement factor in the literature is usually quite misleading since the SERS signal changes significantly across the SERS substrate. Owning to the uniform SERS signal across the SERS substrate, a reliable enhancement factor measurement could be performed.

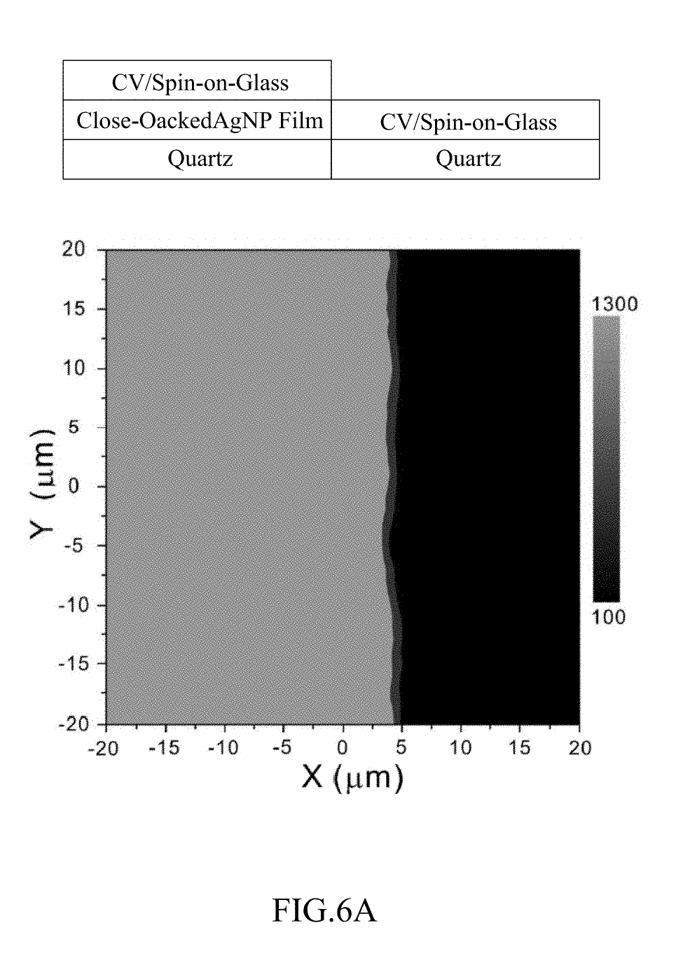

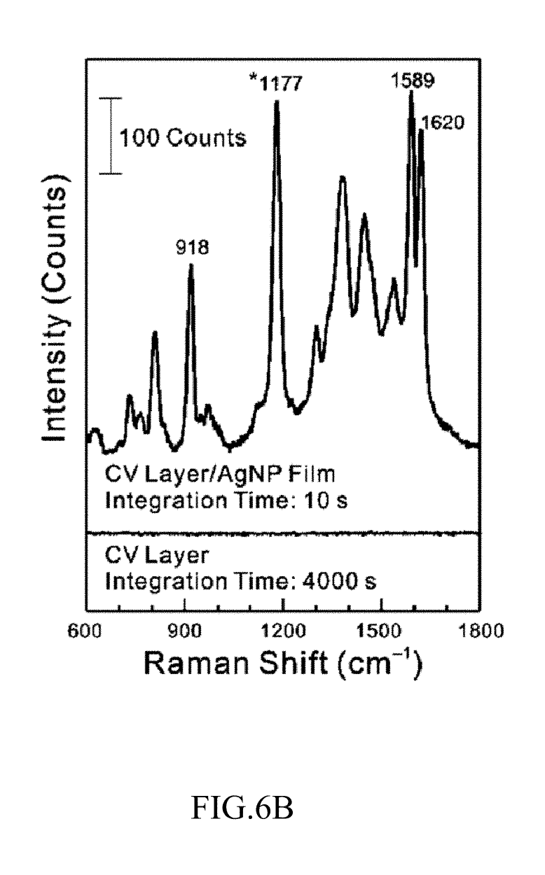

FIGS. 6A and 6B show enhancement factor of AgNP SERS substrate of FIG. 1. FIG. 6A shows SERS mapping near an edge of an AgNP film. The spectra are acquired by using the Raman System II and the integration time is 1 s. The whole area is covered by a CV/SOG layer with an estimated molecule areal density of 5,000/μm². The Raman mapping is clearly separated into two regions, revealing the uniform and large SERS enhancement originated from the AgNP film. FIG. 6B shows two Raman spectra (vertically offset for clarity) obtained from a 5,000-molecules/μm² CV/SOG layer on AgNP film and a 500,000-molecules/μm² CV/SOG layer on quartz, respectively. The enhancement factor can be estimated to be large than 1.2×10⁷, which is derived by 300 (Raman intensity ratio at 1177 cm⁻¹)×400 (integration time ratio)×100 (areal density ratio). The estimated enhancement factor is sufficiently high for single-molecule measurements.¹⁰ A further SERS substrate is made in which an additional SOG dielectric layer is introduced between the analytes and the SERS substrate. The results show that the uniformity is better but the enhancement factor is much lower because of the presence of the additional dielectric layer. Furthermore, according to the FDTD simulations (FIGS. 3A, 3B, and 3C), it is estimated that the enhancement factor at the hottest sites on the AgNP film could be large than 10⁹ because the field intensity is more than ten times stronger. This is consistent with the previous results reported for nanogaps formed by colloidal gold nanoparticles.²¹ An additional experiment shows that large SERS enhancement can also be observed by using the R6G molecules.

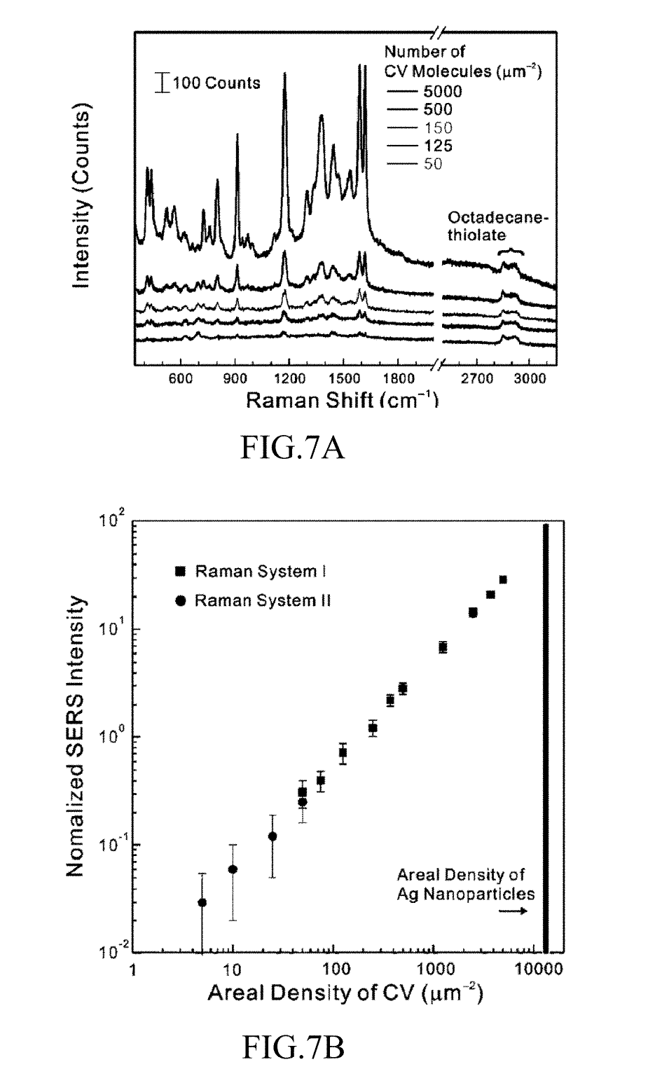

FIGS. 7A and 7B show the quantitative capability of the SERS substrate of FIG. 1. FIG. 7A shows CV-density-dependent SERS spectra (vertically offset for clarity). The spectra were acquired by using the Raman System I and the integration time is 10 s. FIG. 7B shows the normalized CV intensity at 1177 cm⁻¹ as a function of CV molecules. The SERS signal of alkanethiolate ligands (octadecanethiolates) is utilized to calibrate and normalize the SERS signals obtained for CV molecules at different areal densities. The areal densities of CV molecules were varied from 5 to 5,000 molecules per μm². These data are collected from two different Raman instruments, Raman Systems I and II. The error-bar shows the standard deviation of SERS intensities at different sample locations. The error bars are larger at ultralow density levels because of the statistical nature of a Poisson distribution, where the error bars are proportional to I/√N (N is the number of events).

The absolute Raman scattering intensity depends on both instrumental factors (laser power, optical alignment, resolution of spectrometer, and sensitivity of detector, etc.) and other intrinsic properties (scattering cross-sections of Raman modes, wavelength- and/or polarization-dependence on the excitation laser, and bonding configuration of molecules with the substrate, etc.). Therefore, utilizing the Raman intensity to determine the precise concentration of analytes is very difficult. Fortunately, using the SERS substrates of this invention, the Raman signal from the alkanethiolate ligands on AgNPs can be utilized as a stable internal calibration standard for quantitative SERS measurements. The Raman signals of analytes from different instruments are now accountable by normalizing them with respect to the SERS signal from the internal standard. As shown in FIG. 7A, the SERS intensity of CV molecules change proportionally with their areal density (50-5,000 molecules per μm²) in the 5-nm-thick SOG layer, while the SERS intensity of alkanethiolates on the AgNP surface remains at the same level. Thus, a normalized/calibrated CV SERS intensity can be defined by the ratio of SERS intensities from CV and alkanethiolate. FIG. 7B shows that the normalized/calibrated SERS intensities of different CV/SOG layers exhibit a well-defined linear response (correlation coefficient R>0.999) over a wide areal density range (5-5,000 molecules per μm²). Note that these data points are collected from two Raman measurement systems using different measurement conditions. According to the measurement results, this linear relationship can be used as a universal areal density ruler for analyte molecules, such that any analyte density can be quantitatively determined by the normalized (calibrated) analyte SERS signal.

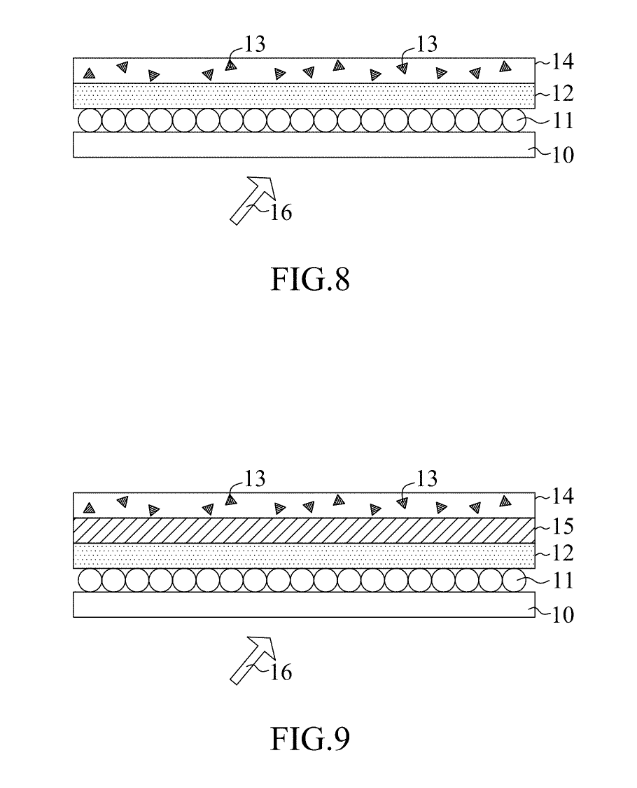

It should be noted that the embodiment of embedding analytes in an ultrathin spin-on-glass layer is for a proof-of-concept experimental study of quantitative SERS. Using this method, both strong Raman enhancement factor for single-molecule detection and high spatial uniformity across the SERS substrate can be achieved. However, it might not be suitable for all analytes to be detected. FIG. 8 shows an analytical SERS substrate according to another embodiment of this invention. In this embodiment, the analytes 13 are dispersed in a fluid 14 displaced on the spin-coated layer 12 instead of being embedded in the spin-coated layer 12. The fluid 12 can also be optionally dried before performing Raman measurements. For the general-purpose SERS applications (especially for the case that analytes are in liquid solutions), referring to FIG. 8, an ultrathin, analyte-free spin-coated (e.g., SOG) layer 12 on the nanoparticle film 11 (e.g., alkanethiolate-regulated AgNP film) is used as a SERS substrate to control the Raman enhancement factor and to achieve high spatial uniformity, while the analytes 13 are dispersed in the nearby medium by using, for example, a microfluidic system.¹⁴ To achieve evanescent detection near the SERS substrate, the total-internal-reflection (TIR) excitation techniqure^{34,35} can be applied to perform TIR Raman spectroscopy.³⁶⁻³⁸ Using this experimental technique, the ultrathin spin-coated layer 12 allows for a highly uniform SERS hot-zone and the evanescent excitation of TIR makes sure that only the analytes in close proximity to the SERS substrate are detected. One additional advantage is that the built-in internal SERS standard (e.g., thiolate ligands) in this quantitative SERS approach is not affected by the location of analytes (within the spin-coated layer 12 or in the optical evanescent field 14).

FIG. 9 shows a SERS substrate according to another embodiment of this invention. In this embodiment, an adsorption layer 15 may be formed on the spin-coated layer 12 and the analytes 13 are dispersed in a nearby medium by using, for example, a microfluidic system 14 or a fluid 14. The adsorption layer 15 is used to adsorb the analytes 13 dispersed in the fluid 14.

Accordingly, reliable, scalable, and tunable SERS substrates are developed for quantitative SERS measurements and the limit of detection (LOD) can be down to single molecule level. This is achieved by the precise control of SERS enhancement factor and detection hot zone using ligand-regulated nanoparticle superlattices film with a built-in internal standard. The establishment of quantitative SERS technique will open up many exciting opportunities for both fundamental and applied research areas.

Although specific embodiments have been illustrated and described, it will be appreciated by those skilled in the art that various modifications may be made without departing from the scope of the present invention, which is intended to be limited solely by the appended claims.

What is claimed is:

1. A surface enhanced Raman spectroscopy (SERS) substrate for Raman measurements, comprising:
a substrate having a first surface for receiving a light beam from a SERS detection equipment and a second surface opposite to the first surface;
a nanoparticle film being formed on the second surface of the substrate and comprising a first monolayer consisted of a two-dimensional nanoparticles array that are near-field coupled with each other;
a spin-coated layer on the nanoparticle film; and
one or more analytes embedded in the spin-coated layer or dispersed in a fluid on the spin-coated layer.

2. The SERS substrate as recited in claim 1, wherein the limit of detection of the SERS substrate is single molecule level.

3. The SERS substrate as recited in claim 1, wherein Raman spectra from the SERS substrate has a linear response with a correlation coefficient R>0.999 over an areal density range 5-5,000 molecules per μm².

4. The SERS substrate as recited in claim 1, wherein the Raman peak intensity of Raman spectra from the SERS substrate has a standard deviation less than 5%.

5. The SERS substrate as recited in claim 1, wherein the substrate comprises a quartz, an indium tin oxide (ITO), a silicon, or a polymer substrate.

6. The SERS substrate as recited in claim 1, wherein the spin-coated layer is a dielectric layer made by a spin coating procedure.

7. The SERS substrate as recited in claim 6, wherein the spin-coated layer is a spin-on-glass (SiO₂) layer.

8. The SERS substrate as recited in claim 6, wherein the spin-coated layer is a spin-coated polymer layer.

9. The SERS substrate as recited in claim 1, further comprising an adsorption layer formed on the spin-coated layer and the one or more analytes are dispersed in the fluid displaced on the spin-coated layer.

10. The SERS substrate as recited in claim 1, wherein the nanoparticle film is made by the steps of:
preparing a nanoparticle solution, which comprises a solvent and supersaturated nanoparticles with surface ligand molecules; and
dip coating the substrate to the nanoparticle solutions to form the first monolayer of the nanoparticles on the substrate, the first monolayer of the nanoparticles constructing the nanoparticle film.

11. The SERS substrate as recited in claim 1, further comprising a second monolayer disposed on the first monolayer, wherein the second monolayer is consisted of a two-dimensional nanoparticles array that are near-field coupled with each other, and the gap of nanoparticles between the first monolayer and the second monolayer are also near-coupled with each other.

12. The SERS substrate as recited in claim 11, wherein both the first monolayer and the second monolayer are consisted of same nanoparticles.

13. The nanoparticle film as recited in claim 12, wherein the first monolayer and the second monolayer are consisted of different nanoparticles.

14. The SERS substrate as recited in claim 1, further comprising one or more monolayers disposed on the first monolayer.

15. The SERS substrate as recited in claim 14, wherein the nanoparticle film has tunable plasmonic properties and the tunable plasmonic properties are determined by the number of the monolayers, the material of the nanoparticles, the size of the nanoparticles, and the gap between nanoparticles.

16. The SERS substrate as recited in claim 14, wherein nanoparticles between two next monolayers (inter-monolayer) are near-field coupled with each other.

17. The SERS substrate as recited in claim 1, wherein the nanoparticles are made of a metal or a core coated with a metal.

18. The SERS substrate as recited in claim 17, wherein the metal comprises gold or silver.

19. The SERS substrate as recited in claim 1, wherein the nanoparticles comprise gold or silver nanoparticles with surface ligand molecules.

20. The SERS substrate as recited in claim 19, wherein the surface ligand molecules comprise alkanethiols.
